(19) United States
(12) Patent Application Publication
(10) Pub. No.: US 2015/0112757 A1
(43) Pub. Date: Apr. 23, 2015

(54) INSIGHT MARKET

(71) Applicant: International Business Machines Corporation, Armonk, NY (US)

(72) Inventors: Konstantinos Bekas, Adliswil (CH); Aris Gkoulalas-Divanis, Dublin (IR); Jia Yuan Yu, Dublin (IR)

(73) Assignee: International Business Machines Corporation, Armonk, NY (US)

(21) Appl. No.: 14/061,163

(22) Filed: Oct. 23, 2013

(51) Int. Cl. G06Q 30/02

(52) U.S. Cl. CPC G06Q 30/0201; G06Q 30/0283
USPC 705/7.29

(57) ABSTRACT

In one embodiment, a computer-implemented method includes receiving a plurality of belief signals from a plurality of parties, where each belief signal indicates a piece of information that a party providing the belief signal believes to be true. A request for an insight is received from an interested party. An insight is determined by evaluating, by a computer processor, a subset of the belief signals. Payment is received from the interested party for the insight. The parties who provided the subset of belief of signals are compensated out of the payment, based on their contribution to the determining the insight.

### BACKGROUND

Various embodiments of this disclosure relate to information exchanges and, more particularly, to insight markets enabling information to be exchanged for compensation.

In many circumstances, business parties may be interested in obtaining or verifying information that their competitors and other parties might already have. For instance, Amazon™ and Expedia™ may have different ways to categorize individual clients in their population of clients. Amazon might be interested in knowing whether a client is likely to purchase luxury items, while Expedia might want to know how many hotel nights a client is likely to book in a year. These pieces of information are constructed from private purchase histories, so neither party will have direct access to the other's purchase histories.

The client populations of Amazon and Expedia may overlap, however, and thus an information exchange might be useful to one or both parties. Amazon might want to know whether Expedia considers a particular client to be a wealthy client, and the information Expedia has about that client's past travel arrangements may be useful to Amazon in making this determination. It might therefore be beneficial for Amazon and Expedia, along with other companies, to be able to exchange information.

### SUMMARY

In one embodiment of this disclosure, a computer-implemented method includes receiving a plurality of belief signals from a plurality of parties, where each belief signal indicates a piece of information that a party providing the belief signal believes to be true. A request for an insight is received from an interested party. An insight is determined by evaluating, by a computer processor, a subset of the belief signals. Payment is received from the interested party for the insight. The parties who provided the subset of belief of signals are compensated out of the payment, based on their contribution to the determining the insight.

In another embodiment, a system includes a belief database, an evaluation unit, and a rewards unit. The belief database is configured to maintain a plurality of belief signals provided by a plurality of parties, where each belief signal indicates a piece of information that a party providing the belief signal believes to be true. The evaluation unit is configured to receive from an interested party a request for an insight; evaluate a subset of the belief signals to determine the insight; and receive from the interested party payment for the insight. The rewards unit is configured to compensate out of the payment the parties who provided the subset of belief signals, based on their contribution to the determining the insight.

In yet another embodiment, a computer program product includes a computer readable storage medium having computer readable program code embodied thereon. The computer readable program code is executable by a processor to perform a method. The method includes receiving a plurality of belief signals from a plurality of parties, where each belief signal indicates a piece of information that a party providing the belief signal believes to be true. Further according to the method, a request for an insight is received from an interested party. An insight is determined by evaluating a subset of the belief signals. Payment is received from the interested party for the insight. The parties who provided the subset of belief of signals are compensated out of the payment, based on their contribution to the determining the insight.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a computing device for implementing some or all aspects of an insight system, according to some embodiments of this disclosure;

FIG. 2 is a block diagram of the insight system, according to some embodiments of this disclosure; and

FIG. 3 is a flow diagram of a method for providing insight to a party upon request, according to some embodiments of this disclosure.

### DETAILED DESCRIPTION

Various embodiments of this disclosure are insight systems and methods enabling parties to exchange information in a manner that compensates the involved parties and encourages accuracy. More specifically, an insight system or method may enable a party to ask a question and receive an answer that complies with a desired level of accuracy, after paying a price based on that level of accuracy, where the parties who contributed to the answer are compensated for their information.

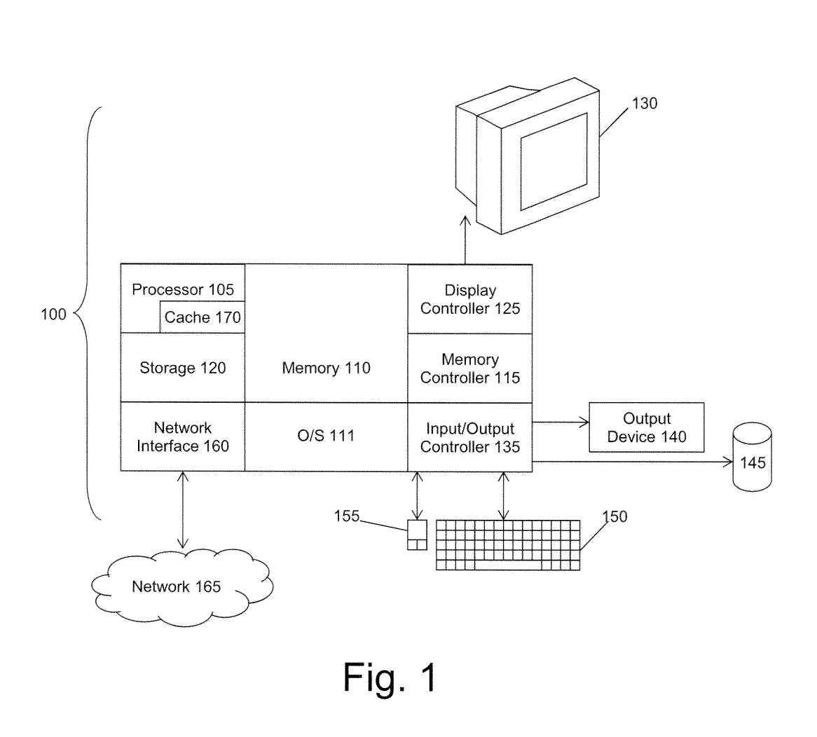

FIG. 1 illustrates a block diagram of a computer system 100 for use in implementing an insight system or method according to some embodiments. The insight systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 100, such as a personal computer, workstation, minicomputer, or mainframe computer.

In an exemplary embodiment, as shown in FIG. 1, the computer system 100 includes a processor 105, memory 110 coupled to a memory controller 115, and one or more input and/or output (I/O) devices 140 and 145, such as peripherals, that are communicatively coupled via a local I/O controller 135. The I/O controller 135 may be for example, one or more buses or other wired or wireless connections, as are known in the art. The I/O controller 135 may have additional elements, which are omitted for simplicity such as controllers, buffers (caches), drivers, repeaters, and receivers, to enable communications.

The processor 105 is a hardware device for executing hardware instructions or software, particularly those stored in memory 110. The processor 105 may be any custom made or commercially available processor, a central processing unit (CPU), an auxiliary processor among several processors associated with the computer system 100, a semiconductor based microprocessor (in the form of a microchip or chip set), a macroprocessor, or other device for executing instructions. The processor 105 includes a cache 170, which may include, but is not limited to, an instruction cache to speed up executable instruction fetch, a data cache to speedup data fetch and store, and a translation lookaside buffer (TLB) used to speedup virtual-to-physical address translation for both executable instructions and data. The cache 170 may be organized as a hierarchy of more cache levels (L1, L2, etc.).

The memory 110 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive or solid state drive. The stored instructions in memory 110 or in storage 120 may include those enabling the processor to execute one or more aspects of the insight systems and methods of this disclosure.

In an exemplary embodiment, a conventional keyboard 150 and mouse 155 may be coupled to the I/O controller 135. Other output devices such as the I/O devices 140 and 145 may include input devices, for example but not limited to, a printer, a scanner, a microphone, and the like. The I/O devices 140, 145 may further include devices that communicate both inputs and outputs, for instance but not limited to, a network interface card (NIC) or modulator/demodulator (for accessing other files, device, systems, or a network), a radio frequency (RF) or other transceiver, a telephonic interface, a bridge, a router, and the like.

The computer system 100 may further include a display controller 125 coupled to a display 130. In an exemplary embodiment, the computer system 100 may further include a network interface 160 for coupling to a network 165. The network 165 may be an IP-based network for communication between the computer system 100 and any external server, client and the like via a broadband connection. The network 165 transmits and receives data between the computer system 100 and external systems. In an exemplary embodiment, the network 165 may be a managed IP network administered by a service provider. The network 165 may be implemented in a wireless fashion, e.g., using wireless protocols and technologies, such as WiFi, WiMax, etc. The network 165 may also be a packet-switched network such as a local area network, wide area network, metropolitan area network, the Internet, or other similar type of network environment. The network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

Insight systems and methods according to this disclosure may be embodied, in whole or in part, in computer program products or in computer systems 100, such as that illustrated in FIG. 1.

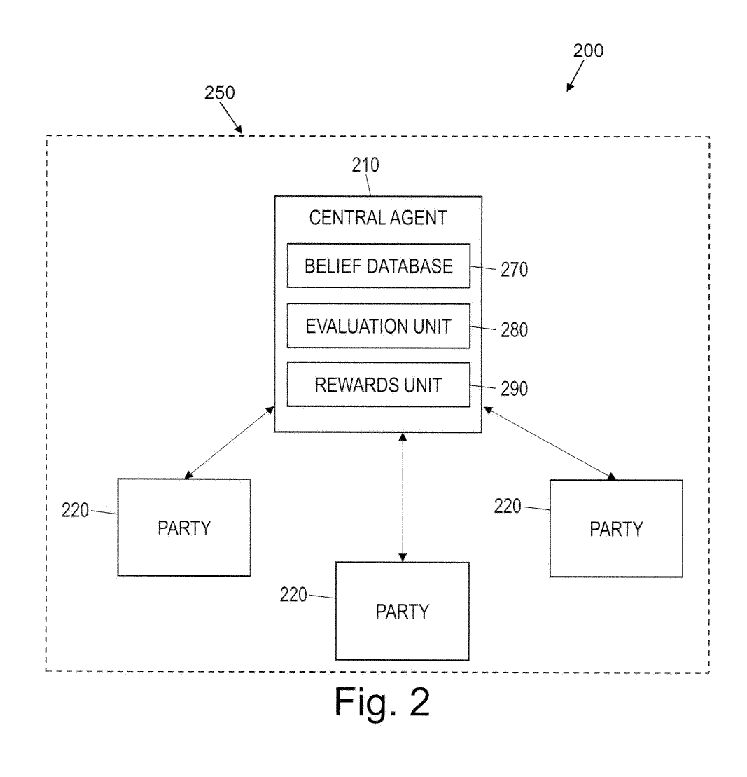

FIG. 2 is a block diagram of an insight system 200, according to seine embodiments of this disclosure. In general, the insight system 200 may enable independent parties to exchange information in return for monetary compensation. A certain party might desire an answer to a question for which it lacks a critical piece of information. Other parties may have that information, which may or may not be useful for their own purposes. The insight system 200 may allow these particles to buy and sell information within a controlled market. In some embodiments, the insight system 200 encourages truthfulness, provides fair compensation for information, and is robust.

As shown, the insight system 201 may include a central agent 210 and two or more parties 220. Among the parties 220, the central agent 210 may establish a market 250 for buying and selling information. Each party 220 may be an entity, such as a company or individual, participating in that market 250. With respect to sales of information, each party 220 may be a seller, a buyer, or both. As will be described further below, the central agent 210 may reward parties 220 whose provided information is deemed to be accurate, further reward parties 220 who provide novel information, and may establish controls that make it costly for parties 220 to make unauthorized sales of information received through the established market 250.

The central agent 210 may include hardware, software, or a combination of both and in some embodiments, may be managed by a human administrator as needed. For example, and not by way of limitation, the central agent 210 may be embodied, in whole or in part, in a computer system 100 such as that shown in FIG. 1. In some embodiments, the central agent may include a belief database 270, and evaluation unit 280, and a rewards unit 290. Generally, the belief database 270 may maintain various belief signals received from the parties 220; the evaluation unit 280 may receive requests for insights, and may evaluate the belief signals to provide insights; and the rewards unit 290 may reward providers for their belief signals. These tasks will be described further below. The belief database 270, the evaluation unit 280, and the rewards unit 290 may be software, hardware, or a combination thereof. As used herein, the term “database” is not limited to a relational database, but may instead include various mechanisms for maintaining data. Further, although the units 270, 280, 290 are depicted as distinct in FIG. 2, this distinction is made for illustrative purposes only, and the hardware, software, or both of these units 270, 280, 290 may overlap or be thither divided based on implementation.

The central agent 210 may receive belief signals from the various parties 220, as well as requests for insights from the various parties 220. The belief signals received may be information the parties 220 believe to be true and are willing to share with other parties 220 for compensation it may be left to the parties 220 themselves to determine what information in their possession is legally allowed to be shared, and to filter information as needed to comply with privacy laws and regulations. With each belief signal, a party 220 may also indicate how that belief signal may be used by the central agent 210. For instance, a party 220 may indicate that the central agent 210 may use the belief signal to answer only a certain type of requests from other panics 220. The central agent 210 may use the belief signals it receives to answer each request with an insight, in compliance with guidelines on those belief signals provided by the associated parties 220. As used in this disclosure, an “insight” refers to information determined from the belief signals of one or more parties 220.

On occasion, an interested party 220 may desire information that it does not currently have, or may desire verification of information is already has. Instead of searching for potential holders of that information, the interested party 220 can submit to the central agent 210 a request for an insight related to that information.

The request may include, for example, a query and an indication of a desired precision for the resulting insight in response to the request. Within the request, the query may indicate what information is being requested. For example, and not by way of the query may be a question, or a statement the interested party 220 wishes to verify. For instance, an example query is: “What is Client A's annual income?” The resulting insight in response to such a question might enable the interested party 220 to provide more finely targeted marketing to Client A. In the request, the requested precision may be represented in various ways, which may be dependent on the query. For instance, in the above example query, the interested party may request, with respect to precision, that the requested insight be provided as a range spanning no more than $20,000. In some cases, the request may also include the interested party's initial belief signal with respect to the query. The initial belief signal may indicate what the interested party 220 believes is the answer to the query, or may be some belief related to the desired insight.

The request may also include special constraints, such as forbidden parties 220 or other guidelines. If a party 220 is forbidden, then information from that forbidden party 220 may be excluded from contributing to the resulting insight. A party 220 may be forbidden, for instance, if the interested party 220 does not trust information from that party 220.

Generally, it may be expected that not all belief signals received will be relevant to every request. Thus, the central agent 210 may likely use only a subset of the insights received in answering each request from an interested party 220. In some embodiments, the central agent 210 may also query one or more parties 220, requesting certain types of belief signals, which might, be used to answer a specific request received from one of the parties 220. Alternatively, in some other embodiments, the central agent 210 may use only the belief signals previously received, rather than sending out tailored queries.

After receiving a request from an interested party 220, the central agent 210 may determine a resulting insight, i.e., an answer to the request that is based on one or more belief signals from other parties 220. If the interested party 220 provided a desired precision level, the central agent 210 may compute a resulting insight that complies with that desired precision, it reasonably possible. The insight, and the determination of the insight, may take various forms, depending on the specific query and the implementation of the insight system 200. For example, and not by way of limitation, given the above query regarding Client A's income, the resulting insight may be a list of possible incomes, some or all of which may be drawn from other parties' belief signals. Alternatively, the insight may be a range, for example: “Client A's annual income is between $200,000 and $220,000.” Determination of the insight may involve, for example, simply compiling the belief signals, or further making estimations based on various belief signals received. For instance, if the central agent 210 has believe signals related to huge purchases made by Client A, or regarding Client A's mortgage payment amount, this information may be useful in estimating Client A's income and thereby developing an insight.

In some embodiments, an insight may include, instead of or in addition to a straight answer to the query, a list of one or more specific belief signals that contributed to that answer. This further information might be useful the interested party 220 in some casts. For instance, the interested party 220 might decide that one or more of the belief signals are not useful, and may indicate such to the central agent 210, which may in turn disfavor the parties who contributed those belief signals from future insights determined for the interested party 220.

After determining the insight, the central agent 210 may quote an insight price back to the interested party 220. In some embodiments, this quote may be calculated and transmitted after the resulting insight is computed. As a result, the quote may be based at least in part on characteristics of the resulting insight. For instance, the quote may be based the quantity of other parties' belief signals contributing to the resulting insight, the precision of the resulting insight, the cost to the central agent 210 of computing the insight, or other factors. A lower level of precision may result in a lower price. In some further embodiments, the central agent 210 may provide two or more options for precision level of the resulting insight, where a lower level of precision may result in a lower price to the interested party 220. If the interested party 220 submitted its own initial belief signal along with the initial request, indicating the interested party's expected answer to the query, then that initial belief signal inn also play a role in pricing. More particularly, the degree of difference between the initial belief signal and the resulting insight may be considering in the price, such that the price may be lower if the initial belief signal was relative close to the resulting insight, and higher is the initial belief signal was far away from the resulting insight.

In some embodiments, the quote may further include art amount for a deposit, to be paid by the interested party 220. The deposit may be used to discourage the interested party 220 from sharing the insight with other parties, outside of the established market. If, after the insight is paid for and delivered, the central agent 210 determines that the insight has been shared with another party 220, the central agent may keep the deposit. Otherwise, the deposit may be refunded to the interested party 220 after a redefined time period during which the central agent 210 had not determined that the insight has been shared.

After a quote is transmitted by the central agent 210 and received by the interested party 220, the interested party 220 may pay the central agent 220 in line with the quote. If two or more precision options were presented, the payment amount may determine which level of precision is provided in the resulting insight delivered to the interested party 220. When payment is received, the central agent 210 may transmit to the interested party 220 the resulting insight, which may include an identifier, or watermark. The identifier may be integrated into the resulting insight as noise, in a manner that, in some embodiments, may be unrecognizable as an identifier. For instance returning to the example query about the income of Client A, the resulting insight may include a list of possible incomes of Client A. That list may include belief signals how other parties 220, which in this case may be Client A's income according to their knowledge. The list may also include a false belief signal, which in this example may be an income not received from the other parties 220 but fabricated by the central agent 210. This false belief signal may behave as an identifier, because if the central agent 210 later receives a belief signal from another party 220 related to Client A's income, where that belief signal is or appears to integrate this false belief signal, it can be assumed that the interested party 220 that received the resulting insight passed that information along to another party 220.

Some embodiments of the insight system 200 may award parties 220 for telling on each other with respect to information from insights having been shared in an unauthorized manner. For example, if Party X shows the central agent 210 that Party X is in possession of Parts Y's received insight, including the accompanying identifier, not only may Party Y lose its deposit, but also Party X may receive a portion of that deposit as a reward for informing the central agent 210. Thus, parties may be further discouraged from sharing information in an unauthorized manner, as they are aware that other parties 220 benefit from telling on be if they do. Further, in some embodiments, a parts 220 that shared in an unauthorized manner may be further punished in addition to, or alternatively to, losing the deposit. For example, that sharing party 220 may be excluded from the insight market 250 permanently or for a limited period.

A portion of the paid insight price may be retained by the central agent 210, or service provider of the central agent 210, as commission. The remainder of price received may be distributed to one or more of the other parties 220 who provided belief signals that contributed to the insight, as reward km their belief signals. The central agent 210 may use a rewards formula to determine the reward due to each contributing other party 220.

In some embodiments, the rewards formula may provide rewards proportional to the value of the contributing parties' belief signals. For instance, higher rewards may be provided for belief signals that played a greater contribution in the resulting insight, as opposed to a lower reward to parties whose belief signals played a lesser contribution. The value of a belief signal's contribution to the resulting insight may be determined in various ways. For example, a belief signal that was an outlier as compared to the other belief signals relevant to the interested party's request may be deemed to have a low contribution, or no contribution, to the resulting insight. A belief signal that provided novel information may be deemed to provide a relatively high contribution. Regarding the above example about Client A's annual income a party 220 that provides a belief signal including Client A's mortgage payment amount, which may be relevant to estimating income, where no other party 220 provides input about the mortgage payment, may be deemed to provide a high contribution due to its novelty and importance in estimating income. In contrast, if multiple parties provide belief signals about what kind of car Client A drives, each of these belief signals may be deemed to have as lower contribution as these belief signals were not difficult to procure. The specific formulas used to value the contributions of belief signals, and to determine how the rewards are distributed for a resulting insight may vary based on implementation.

By observing their rewards and insight prices, the various parties 220 in the market 250 may learn how much their information is worth and the cost of additional information. The parties 220 can therefor adapt their actions over time. Likewise, the central agent 210 may adapt over time to encourage more belief signals and insight requests. For example, the central agent 210 may change its pricing and reward formulas.

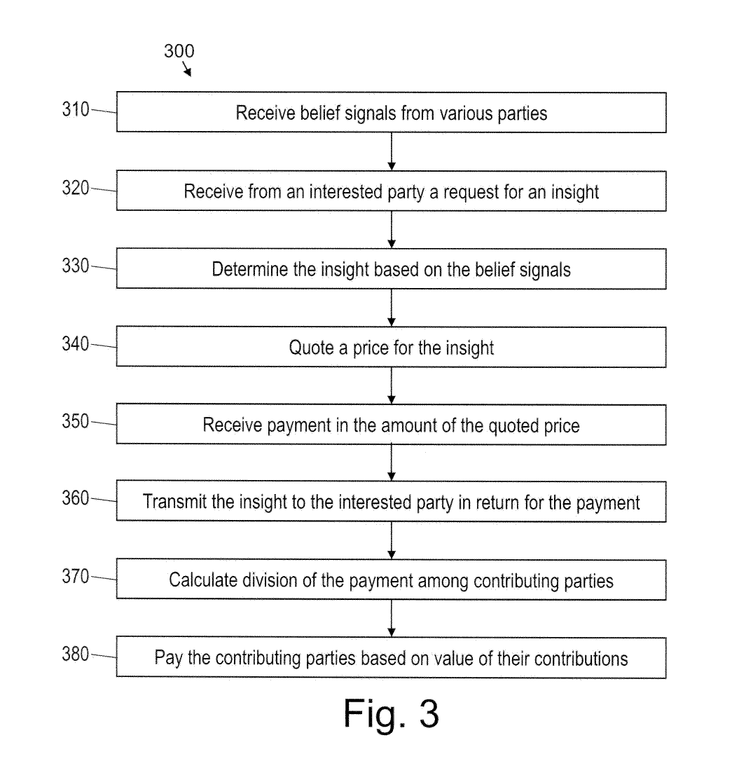

FIG. 3 is a flow diagram of a method 300 for providing an insight in an insight market 250, according to some embodiments of this disclosure. As shown, at block 310, the central agent 210 may receive belief signals from various parties 220. At block 320, the central agent 210 may receive from an interested party 220 a request for an insight. At block 330, the central agent 210 may determine a resulting insight fir the request, based at least in part on the belief signals received from the various parties 220. At block 340, the central agent 210 may quote a price for the insight. In some embodiments, this price may include a deposit, which may be used to discourage unauthorized sharing, of the insight. At block 350, the central agent 210 may receive payment in the amount of the quoted price from the interested party 220. At block 360, the central agent 210 may transmit the insight to the interested party 220 in return for the price paid. At block 370, the central agent 210 may calculate how to divide the payment among the parties 220 whose belief signals contributed to the insight. This calculation may include application of a predefined rewards formula. At block 380, the central agent 210 may pay the parties 220 who contributed to the insight based on the values of their respective contributions. It will be understood that this method 300 may vary across embodiments of the insight systems 200 and methods 300.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing nom the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
receiving a plurality of belief signals from a plurality of parties, each belief signal indicating a piece of information that a party providing the belief signal believes to be true;
receiving from an interested party a request for an insight;
evaluating, by a computer processor, a subset of the belief signals to determine the insight;
receiving from the interested party payment for the insight; and
compensating out of the payment the parties who provided the subset of belief signals, based on their contribution to the determining the insight.

2. The method of claim 1, further comprising calculating a compensation for each of the parties who provided a belief signal in the subset of belief signals, wherein each compensation is based on a calculated value of the associated party's contribution to the insight.

3. The method of claim 1, further comprising calculating a price for the insight based at least in part on a precision level of the insight.

4. The method of claim 1, further comprising:
receiving an initial belief signal from the interested party, the initial belief signal indicating the interested party's expectation about the insight; and
calculating a price for the insight based at least in part on a degree of difference between the insight and the belief signal.

5. The method of claim 1, further comprising penalizing the interested party if it is determined that the interested party shared the insight with a second party.

6. The method of claim 5, further comprising:
embedding an identifier in a data portion of the insight; and
receiving a deposit for the insight as part of the payment;
wherein penalizing the interested party comprises retaining the deposit if it is determined that a second party has possession of the identifier.

7. The method of claim 1, further comprising:
receiving a requested precision level from the interested party as part of the request; and
calculating an amount for the payment based at least in part on the requested precision level;
wherein the insight is based at least partially on the precision level.

8.-14. (canceled)

15. A computer program product comprising a computer readable storage medium having computer readable program code embodied thereon, the computer readable program code executable by a processor to perform a method comprising:
receiving a plurality of belief signals from a plurality of parties, each belief signal indicating a piece of information that a party providing the belief signal believes to be true;
receiving from an interested party a request for an insight;
evaluating a subset of the belief signals to determine the insight;
receiving from the interested party payment for the insight; and
compensating out of the payment the parties who provided the subset of belief signals, based on their contribution to the determining the insight.

16. The computer program product of claim 15, the method further comprising calculating a compensation for each of the parties who provided a belief signal in the subset of belief signals, wherein each compensation is based on a calculated value of the associated party's contribution to the insight.

17. The computer program product of claim 15, the method further comprising calculating a price for the insight based at least in part on a precision level of the insight.

18. The computer program product of claim 15, the method further comprising:
receiving an initial belief signal from the interested party, the initial belief signal indicating the interested party's expectation about the insight; and
calculating a price for the insight based at least in part on a degree of difference between the insight and the belief signal.

19. The computer program product of claim 15, the method further comprising:
embedding an identifier in a data portion of the insight;
receiving a deposit for the insight as part of the payment; and
retaining the deposit if it is determined that a second party has possession of the identifier.

20. The computer program product of claim 15, the method further comprising:
receiving a requested precision level from the interested party as part of the request; and
calculating an amount for the payment based at least in part on the requested precision level;
wherein the insight is based at least partially on the precision level.
